(19) United States
(12) Patent Application Publication
(10) Pub. No.: US 2015/0235247 A1
(43) Pub. Date: Aug. 20, 2015

(54) COMPUTER IMPLEMENTED SYSTEM AND METHOD FOR DETERMINING A MULTI STAGE FACILITY LOCATION AND ALLOCATION

(71) Applicant: Tata Consultancy Services Limited, Mumbai (IN)

(72) Inventors: Avneet SAXENA, Bangalore (IN); Ashok Kumar Reddy POLU, Bangalore (IN)

(21) Appl. No.: 14/311,986

(22) Filed: Jun. 23, 2014

(30) Foreign Application Priority Data
Feb. 19, 2014 (IN) 578/MUM/2014

(51) Int. Cl. G06Q 30/02

(52) U.S. Cl. CPC G06Q 30/0205

(57) ABSTRACT

Disclosed is a method and system for determining a location of a facility. A population size, a crossover rate, and a mutation rate for the region along with geo-spatial co-ordinates of customer locations are received. Further, initial seeds and offspring seeds are generated in the region based on the population size, and the crossover rate along with the mutation rate. Further, one or more solutions are generated for the region by applying a k-means algorithm and a simulated annealing algorithm on the initial seeds and the offspring seeds. Furthermore, the one more solutions are compared in order to obtain a preliminary optimal solution having a shortest distance from the customer locations. The preliminary optimal solution is optimized using MILP model in order to obtain a final multi objective optimal solution reflecting a location for placement of the facility with many strategic to operational decision scenarios.

### CROSS-REFERENCE TO RELATED PATENT APPLICATIONS

This U.S. patent application claims the benefit of priority under 35 U.S.C. §119 to India Patent Application No. 578/MUM/2014, filed on Feb. 19, 2014. The aforementioned application is incorporated herein by reference in its entirety.

### TECHNICAL FIELD

The present disclosure described herein, in general, relates to systems and methods for determining a facility location to be setup in a region for catering customer locations present in the region.

### BACKGROUND

In a supply chain network design, facility locations including but not limited to warehouses, distributors, manufacturing units, cross docks, or retailer's locations play an important role in driving efficient distribution planning and satisfying customer service level. The decision to open the facility locations catering the requirements of the customer location is significant and depends on multiple factors including service level constraints, cost constraints, and time constraints. It is essential to analyze the aforementioned constraints in order to identify facility locations that may cater to the requirements of the customer locations. Specifically, the allocation of the facility locations to the customer locations is to be done so as to optimize supply chain network cost and services.

Computer-based clustering techniques have been implemented in the art in order to identify the facility locations and thereafter allocate the facility locations to the customer locations. One of the clustering techniques utilizes a K-means algorithm in order to identify the cluster of customers (i.e. indicative facility locations) to minimize distance in supplying goods or products to retailers or customers. However, solution obtained from the k-means algorithm is sensitive to initial seed. More specifically, the k-means algorithm depends on initial selection of cluster seeds at the beginning of the clustering. The k-means algorithm is further limited to provide the solution that is based on distance and time constraints and hence does not consider the other constraints associated to the facility locations including service levels, logistics, customer demands, and facility location capacities.

Additionally, the existing clustering technique is not efficient in case of scenarios wherein the locations where the facility locations are to be set up are unknown (also referred to a green field problem). More particularly, the existing computer based techniques provide solutions indicative of potential facility location by the k means algorithm. Similarly, priorities (customer range, customer density, service level, percentage of demand) based solution wherein the locations where the facilities are to be set up are known (also referred to a brown field problem) are not available. These scenarios are applicable when the locations wherein such potential warehouses are to be set up are known beforehand.

### SUMMARY

This summary is provided to introduce aspects related to systems and methods for determining a facility location to be setup in a region for catering customer locations present in the region and the aspects are further described below in the detailed description. This summary is not intended to identify essential features of the claimed disclosure nor is it intended for use in determining or limiting the scope of the claimed disclosure.

In one embodiment, a system for determining a location of a facility is disclosed. The system may comprise one or more hardware processors and one or more memory unites storing machine-readable instructions executable by the one or more processors. The instructions may include receiving a plurality of variables, including a population size, a crossover rate, and a mutation rate associated with a region, and geo-spatial coordinates associated with customer locations located in the region. The instructions may also include generating initial seeds for the region based on the population size, the initial seeds reflecting a first set of potential facility locations, and generating offspring seeds by applying a genetic algorithm on a sub-set of the initial seeds using the crossover rate and the mutation rate, the offspring seeds reflecting a second set of potential facility locations. The instructions may further include generating a first solution and a second solution associated with the region by applying a k-means algorithm on the initial seeds and on the offspring seeds, the first solution including a first portion of the initial seeds having a distance from the customer locations within a predefined range, and the second solution including a first portion of the offspring seeds having a distance from the customer locations within a predefined range; and generating a third solution and a fourth solution associated with the region by applying a simulated annealing algorithm and the k-means algorithm on the initial seeds and the offspring seeds, the third solution including a second portion of the initial seeds having a distance from the customer locations within the predefined range, and the fourth solution including a second set of offspring seeds having a distance from the customer locations within the predefined range. Furthermore, the instructions may include comparing the distances of the first solution, the second solution, the third solution, and the fourth solution in order to obtain a preliminary optimal solution having a shortest distance from the customers locations; and determining a final optimal solution by applying Mixed-integer linear programming (MILP) on the preliminary optimal solution using a cost constraint, a time constraint, and a service constraint, the final optimal solution reflecting a location in the region for placement of the facility.

In another implementation, a computer implemented method for determining a location of a facility disclosed. The method may include receiving, by one or more processors, a plurality of variables, including a population size, a crossover rate, and a mutation rate associated with a region, and geo-spatial coordinates associated with customer locations located in the region. The method may also include generating, by the one or more processors, initial seeds for the region based on the population size, the initial seeds reflecting a first set of potential facility locations; and generating, by the one or more processors, offspring seeds by applying a genetic algorithm on a sub-set of the initial seeds using the crossover rate and the mutation rate, the offspring seeds reflecting a second set of potential facility locations. The method may further include generating, by the one or more processors, a first solution and a second solution associated with the region by applying a k-means algorithm on the initial seeds and on the offspring seeds, the first solution including a first portion of the initial seeds having a distance from the customer locations within a predefined range, and the second solution including a first portion of the offspring seeds having a distance from the customer locations within a predefined range; and generating, by the one or more processors, a third solution and a fourth solution associated with the region by applying a simulated annealing algorithm and the k-means algorithm on the initial seeds and the offspring seeds, the third solution including a second portion of the initial seeds having a distance from the customer locations within the predefined range, and the fourth solution including a second set of offspring seeds having a distance from the customer locations within the predefined range. The method may additionally include comparing the distances of the first solution, the second solution, the third solution, and the fourth solution in order to obtain a preliminary optimal solution having a shortest distance from the customers locations; and determining, by the one or more processors, a final optimal solution by applying Mixed-integer linear programming (MILP) on the preliminary optimal solution using a cost constraint, a time constraint, and a service constraint, the final optimal solution reflecting a location in the region for placement of the facility.

In yet another implementation, a non-transitory computer readable medium storing machine readable instructions executable by one or more processors is disclosed. The instructions may be executed for receiving a plurality of variables, including a population size, a crossover rate, and a mutation rate associated with a region, and geo-spatial coordinates associated with customer locations located in the region. The instructions may be further executed for generating initial seeds for the region based on the population size, the initial seeds reflecting a first set of potential facility locations; and generating offspring seeds by applying a genetic algorithm on a sub-set of the initial seeds using the crossover rate and the mutation rate, the offspring seeds reflecting a second set of potential facility locations. The instructions may be additionally executed for generating a first solution and a second solution associated with the region by applying a k-means algorithm on the initial seeds and on the offspring seeds, the first solution including a first portion of the initial seeds having a distance from the customer locations within a predefined range, and the second solution including a first portion of the offspring seeds having a distance from the customer locations within a predefined range; and generating a third solution and a fourth solution associated with the region by applying a simulated annealing algorithm and the k-means algorithm on the initial seeds and the offspring seeds, the third solution including a second portion of the initial seeds having a distance from the customer locations within the predefined range, and the fourth solution including a second set of offspring seeds having a distance from the customer locations within the predefined range. Moreover, the instructions may be executed for comparing the distances of the first solution, the second solution, the third solution, and the fourth solution in order to obtain a preliminary optimal solution having a shortest distance from the customers locations; and determining a final optimal solution by applying Mixed-integer linear programming (MILP) on the preliminary optimal solution using a cost constraint, a time constraint, and a service constraint, the final optimal solution reflecting a location in the region for placement of the facility.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a network implementation of a system for determining a facility location to be setup in a region for catering customer locations present in the region, in accordance with an embodiment of the present disclosure.

FIG. 2 illustrates the system, in accordance with an embodiment of the present disclosure.

FIG. 3 illustrates a method for determining a facility location to be setup in a region for catering customer locations present in the region, in accordance with an embodiment of the present disclosure.

### DETAILED DESCRIPTION

Systems and methods for determining a facility location to be setup in a region for catering customer locations present in the region are described. In one example, the facility location comprises a warehouse location, a retailer location, a manufacturer location, a store location, and a service provider location. In order to determine the facility location and thereby allocate the facility location to the customer locations, the system employs a Meta heuristic algorithm (combination of K Means, Genetic Algorithm (GA) and Simulated Annealing (SA)) and a Mixed-integer linear programming (MILP) based mathematical model.

The Meta heuristic enables to optimize clustering of the customer locations in order to identify known, unknown and priority facility locations. The system provides a highly flexible hybrid clustering decision support modules developed in Java™ platform which can be installed with any platform and compatible with any database. The system is flexible to allow users to execute various scenarios for the identification of the known, the unknown, and the priority facility locations and thereby allocate the known, the unknown and the priority facility locations to the customer locations. The facility locations are identified using clustering techniques with distance optimization. Specifically, the system facilitates improving existing k means algorithm by combining the k means algorithm with Genetic algorithm and the simulated annealing technique in order to determine a solution indicative of potential facility locations.

The solution obtained from the Meta heuristic and/or the hybrid clustering is optimum with respect to distance, however in real world scenario, lot of other key constraint and parameters play vital role in network planning, facility decision, cost minimization, service maximization and capacity utilization to minimize inventory. Therefore, the present system employs the MILP based mathematical model in order to further optimize the solution based upon a plurality of constraints, included but not limited to logistics, operational and inventory costs, service level, capacity constraints, distribution constraints as lead time, and fleet constraints, and the line in order to meet optimum supply chain network cost and services. The MILP based mathematical model facilitates the users to execute various scenarios in a dynamic supply chain environment.

The MILP based mathematical model is enhanced and integrated with the Meta heuristic and/or the hybrid clustering in order to obtain final optimum solution that indicates the final facility location for the customer locations. The MILP based mathematical model is formulated using a preliminary optimal solution obtained from the Meta heuristic and/or the hybrid clustering in order to consider practical constraints including cost constraint, time constraint, and service constraint. The cost constraint comprises facility location fixed cost, salvage cost, variable cost, and transportation cost. The time constraint comprises road constraint, service level distance constraint, customer allocation constraint, and demand allocation constraint. The service constraint comprises capacity of the facility location, number of the facility locations to be setup, penalty for unsatisfied demand, priority facility location, and safety stock constraint.

While aspects of described system and method for determining a facility location to be setup in a region for catering customer locations present in the region may be implemented in any number of different computing systems, environments, and/or configurations, the embodiments are described in the context of the following exemplary system.

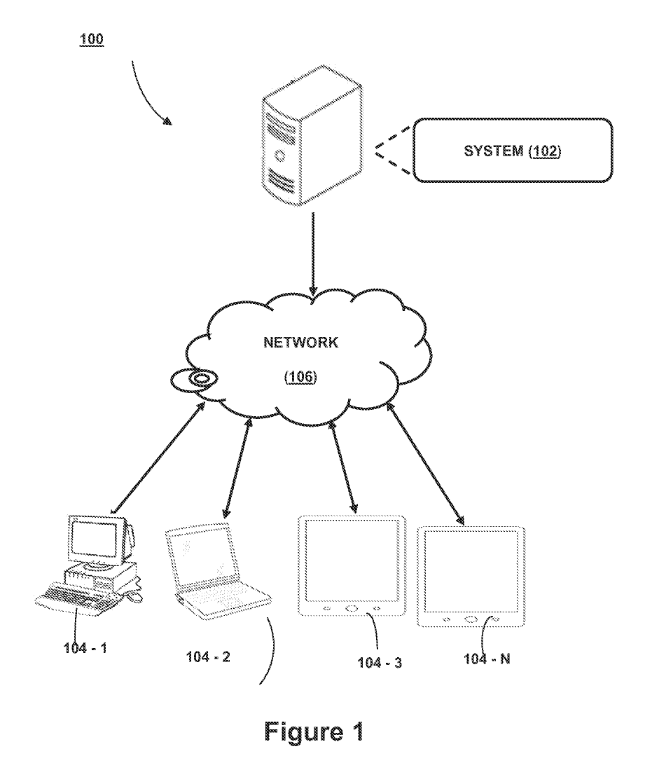

Referring now to FIG. 1, a network implementation 100 of a system 102 for determining a facility location to be setup in a region for catering customer locations present in the region is illustrated, in accordance with an embodiment of the present disclosure. In one embodiment, the system 102 may be configured to receive a plurality of variables comprising a population size, a crossover rate, and a mutation rate for the region. Further, the system 102 may be configured to receive geo-spatial co-ordinates of the customer locations. The system 102 may be configured to generate initial seeds in the region based on the population size. The initial seeds indicate a first set of potential facility locations. Further, the system 102 may be configured to generate offspring seeds by applying genetic algorithm on a sub-set of the initial seeds using the crossover rate and the mutation rate. The offspring seeds indicate a second set of potential facility locations. The system 102 may be configured to generate a first solution and a second solution for the region by applying a k-means algorithm on the initial seeds and on the offspring seeds respectively. The first solution indicates a first set of the initial seeds having a distance within a predefined range from the customer locations. Further, the second solution indicates a first set of offspring seeds having a distance within a predefined range from the customer locations. The system 102 may be further configured to generate a third solution and a fourth solution for the region by applying simulated annealing algorithm and the k-means algorithm on the initial seeds and the offspring seeds respectively. The third solution indicates a second set of the initial seeds having a distance within the predefined range from the customer locations. The fourth solution indicates a second set of offspring seeds having a distance within the predefined range from the customer locations. The system 102 may be configured to compare distances determined in the first solution, the second solution, the third solution, and the fourth solution from the customer locations in order to obtain preliminary optimal solution having a least distance from the customer locations. The system 102 may be configured to determine a final optimal solution by applying Mixed-integer linear programming (MILP) on the preliminary optimal solution using a cost constraint, a time constraint, and a service constraint. The final optimal solution indicates the facility location to be set up in the region.

Although the present disclosure is explained considering that the system 102 is implemented as a server, it may be understood that the system 102 may also be implemented in a variety of computing systems, such as a laptop computer, a desktop computer, a notebook, a workstation, a mainframe computer, a network server, and the like. In one implementation, the system 102 may be implemented in a cloud-based environment. It will be understood that the system 102 may be accessed by multiple users through one or more user devices 104-1, 104-2 . . . 104-N, collectively also referred to as a user device 104 hereinafter, or applications residing on the user devices 104. Examples of the user devices 104 may include, but are not limited to, a portable computer, a personal digital assistant, a handheld device, and a workstation. The user devices 104 are communicatively coupled to the system 102 through a network 106.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

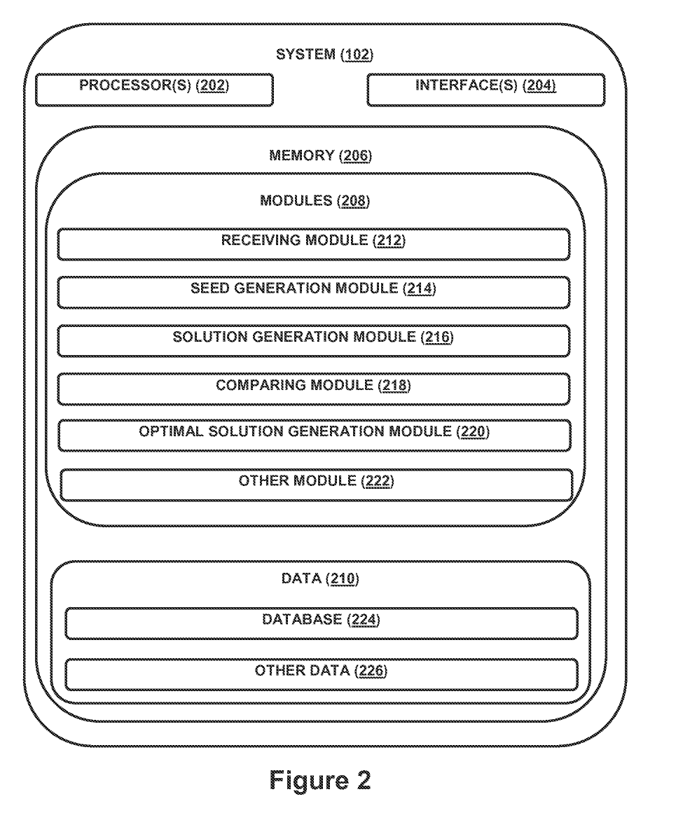

Referring now to FIG. 2, the system 102 is illustrated in accordance with an embodiment of the present disclosure. In one embodiment, the system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions stored in the memory 206.

The I/O interface 204 may include a variety of software and hardware interfaces, for example, a web interface, a graphical user interface, and the like. The I/O interface 204 may allow the system 102 to interact with a user directly or through the user device 104. Further, the I/O interface 204 may enable the system 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208 and data 210.

The modules 208 include routines, programs, objects, components, data structures, etc., which perform particular tasks, functions or implement particular abstract data types. In one implementation, the modules 208 may include a receiving module 212, a seed generation module 214, a solution generation module 216, a comparing module 218, an optimal solution generation module 220, and other module 222. The other module 222 may include programs or coded instructions that supplement applications and functions of the system 102.

The data 210, amongst other things, serves as a repository for storing data processed, received, and generated by one or more of the modules 208. The data 210 may also a database 224 other data 226. The other data 226 may include data generated as a result of the execution of one or more modules in the other module 218.

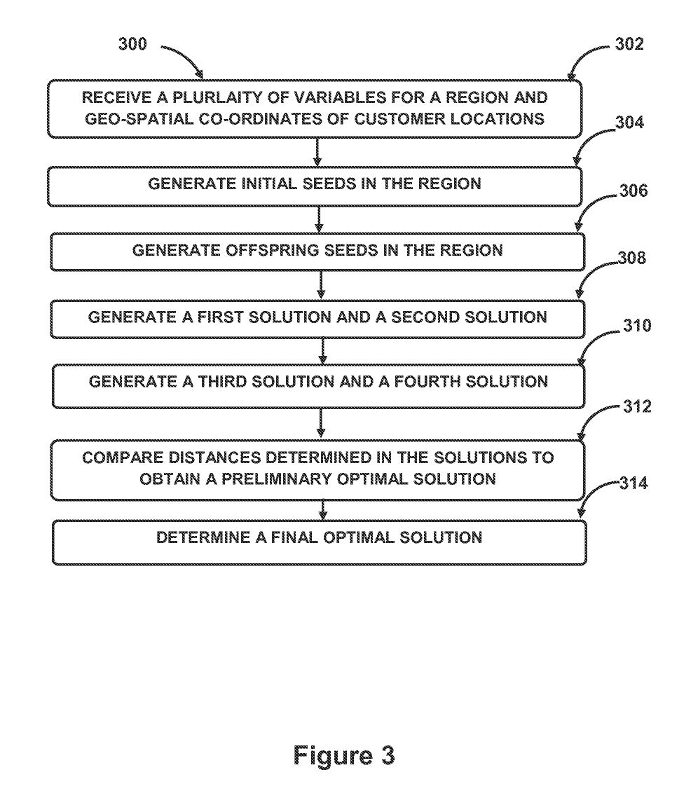

In one implementation, at first, a user may use the user device 104 to access the system 102 via the I/O interface 204. The user may register themselves using the I/O interface 204 in order to use the system 102. The working of the system 102 using the plurality of modules 208 is explained in detail referring to FIGS. 2 and 3 as explained below.

### Receiving Module 212

In an embodiment, the receiving module 212, as shown in FIG. 2, may be configured to receive a plurality of variables comprising a population size, a crossover rate, and a mutation rate for the region. Further, the receiving module 212 may be configured to receive geo-spatial co-ordinates of the customer locations. In one implementation, the geo-spatial co-ordinates comprise information associated to latitude and longitude of the customer locations. Further, the receiving module 212 may be configured to receive a number of facility locations to be set up and a master data set comprising a list of known locations wherein the facility location may be set up. It is to be understood that the receipt of the number of facility locations and master data set may be optional, and the present disclosure is capable of deriving facility locations even if the locations are unknown (green field problem). The plurality of variables, the geo-spatial co-ordinates, the number of facility locations to be set up, and the master data set may be stored in the database 224. After the receipt of the plurality of variables, the geo-spatial co-ordinates, the number of facility locations, and the master data set, the system may be further configured to generate initial seeds and offspring seeds in the region using a seed generation module 214, as described in detail as below.

### Seed Generation Module 214

Subsequent to the receipt of the plurality of variables, the geo-spatial co-ordinates, the number of facility locations, and the master data set, the seed generation module 214 may be configured to generate initial seeds and offspring seeds in the region using the plurality of variables. The initial seeds may be generated based upon the population size. For example, if the population size is 10, then the seed generation module 214 may generate 10 initial seeds. The initial seeds generated may indicate a first set of potential solutions. Each initial seed may comprise the number of potential solutions equivalent to the number of facility locations. In one example, if the number of facility locations to be set up is 7, then each seed of the initial seed will comprise 7 potential solutions. In one embodiment, the potential solutions are one or more customer locations selected from the master data set. Further, the seed generation module 214 may be configured to generate the offspring seeds by applying genetic algorithm on a sub-set of the initial seeds using the crossover rate and the mutation rate. The offspring seeds generated may indicate a second set of potential solutions. The offspring seeds may be generated based upon the population size. For example, if the population size is 10, then the seed generation module 214 may generate 10 offspring seeds. Each offspring seed may comprise the number of potential solutions equivalent to the number of facility locations. In one example, if the number of facility locations to be set up is 7, then each seed of the offspring seed will comprise 7 potential solutions. The generation of offspring springs is further explained in detail as below.

In order to generate the offspring seeds using the crossover rate, the seed generation module 214 may be configured to randomly select one initial seed from the initial seeds and generate a random number. Then it is verified whether the random number generated for the initial seed is less than the crossover rate. The initial seed is tentatively selected for the application of the genetic algorithm. Further, another initial seed is randomly selected, and further, another random number corresponding to another initial seed is generated which is again compared with the crossover rate. Further, based on the comparison another initial seed is tentatively selected. Then, the seed generation module 214 may be configured to compare distances of the initial seed and another initial seed from the customer locations in order to select one of these initial seeds having less distance from the customer locations. The distances may be calculated using k-means algorithm (explained in detail in subsequent paragraphs). The process of selection of the initial seeds is iteratively performed until the number of initial seeds selected for the application of the genetic algorithm is equivalent to the population size. The initial seeds selected indicate chromosomes to be apply for the cross over in the genetic algorithm. Then the chromosomes selected are applied with the cross over operator in order to generate the offspring seeds.

Further, the offspring seeds may be generated using the mutation rate. In order to generate the offspring seeds using the mutation rate, the seed generation module 214 may initially generate a random number, between 0-1, for each seed of the initial seeds. If the random number generated is less than the mutation rate, then a new initial seed is generated corresponding to that initial seed by updating at least one solution present in the said initial seed with a randomly generated number. Thus, using the cross over rate and the mutation rate, the offspring seeds may be generated by the seed generation module 214. The initial seeds and the offspring seeds generated may be stored in the database 224. It is to be understood that the potential solutions comprised in the initial seeds and the offspring seeds are one or more customer locations selected from the master data set. Further, it is to be understood that if the master data set is not available and the locations corresponding to the customer locations are unknown (green field problem), then the seed generation module 214 may be configured to randomly select the potential solutions in the initial seeds and the offspring seeds. After the generation of the initial seeds and the offspring seeds, the system 102 may be further configured to generate one or more solutions using a solution generation module 216, as described below.

### Solution Generation Module 216

Subsequent to the generation of the initial seeds and the offspring seeds, the solution generation module 216 may be configured to initially generate a first solution and a second solution using the k-means algorithm. Specifically, the solution generation module 216 may be configured to generate the first solution by applying the k-means algorithm on the initial seeds. The k-means algorithm is applied on each seed of the initial seed in order to calculate distance of each seed from the customer locations. In one embodiment, the distance may be calculated based on the geo-spatial co-ordinates received for the customer locations. The solution generation module 216 by applying the k-means algorithm generates the first solution which indicates a first set of initial seeds having the distance within a predefined range from the customer locations. Similarly, by applying the k-means algorithm on each offspring seed of the offspring seeds, the solution generation module 216 generates the second solution which indicates a first set of offspring seeds having the distance within the predefined range from the customer locations. The working of the k-means algorithm is further explained in detail as below.

In order to execute the k-means algorithm, initial cluster seeds are chosen as per the initial seed. These initial cluster seeds represent the “temporary” means of the clusters (temporary facility locations). The curve linear distance from each customer location to each cluster (facility location) is computed, and each customer location is assigned to the closest cluster. For each cluster, new centroid is computed, and each seed value is now replaced by the respective cluster centroid. The curve linear distance from a customer location to each cluster centroid is computed, and the customer location is assigned to the cluster centroid with the smallest distance. The cluster centroids are re-calculated based on the new membership assignment. These steps of the computation of the cluster centroid and assignment of membership based on the cluster centroid are iteratively performed until no customer location moves to other clusters. In one embodiment, the first solution and the second solution generated by the solution generation module 216 may be stored in the database 224.

After the generation of the first solution and the second solution, the solution generation module 216 may be configured to generate a third solution and a fourth solution using a simulated annealing algorithm and the k-means algorithm. Specifically, the solution generation module 216 may be configured to generate the third solution by applying the simulated annealing algorithm on the initial seeds. The third solution indicates a second set of initial seeds having the distance within a predefined range from the customer locations. Similarly, by applying the simulated annealing algorithm and the k-means algorithm on each offspring seed of the offspring seeds, the solution generation module 216 generates the fourth solution which indicates a second set of offspring seeds having the distance within the predefined range from the customer locations. The working of the simulated annealing algorithm along with the k-means algorithm for the generation of the third solution and the fourth solution is further explained in detail as below.

In order to execute the simulated annealing algorithm, a temperature (T), a temperature reduction parameter, a first stopping criterion, and a second stopping criterion are initialized. Then an initial seed (seedx) is randomly selected. The initial seed (seedx) is assigned to a current seed (xcurrent), and is considered to be a best seed (xbest). Further, the value of the current seed (xcurrent) is assigned to (x) and as best value f (best). Then, a neighbor seed (seedx′) of the current seed (xcurrent) is generated and k-means algorithm is applied on the neighbor seed (seedx′). Further, the value of the neighbor seed (seedx′) is assigned to x′. Now, If (x′)<f(x), then x′ is assigned to the current seed (xcurrent) and f(x′) is assigned to f(x). After the assignment of (x′) to f(x), it is checked whether (x′)<f (best). If (x′)<f(best), then x′ is assigned to xbest and f(x′) is assigned to f(best). If (x′)>f(x), then probability for accepting x′ may be calculated by using

$${e}^{\frac{f ( {x}^{′} ) - f ( x )}{T}} .$$

Further, random number (within the range of 0-1) may be generated for x′.

$$If {e}^{\frac{f ( {x}^{′} ) - f ( x )}{T}} >$$

random number, then x′ is assigned the current seed (xcurrent), and (x′) is assigned to f(x). This process of generating neighbors of seeds and thereby assignment is iteratively performed until the first stopping criterion is achieved. Then, the value of the temperature T may be reduced by using temperature reduction factor, and the process is iteratively performed with the reduced temperature (T′) until the second stopping criterion is achieved. Thus, by executing the simulated annealing algorithm along with the k-means algorithm on the initial seeds and the offspring seeds, the third solution and the fourth solution may be generated by the solution generation module 216.

In one embodiment, the solution generation module 216 may be configured to update the second solution and the fourth solution by applying the genetic algorithm on a new population of seeds generated using the crossover rate and the mutation rate. The new population of seeds is generated based on a replacement strategy which is explained hereinafter in detail. In the replacement strategy, the initial seeds selected for the execution of the genetic algorithm and having the distance greater than the predefined range are excluded. The remaining seeds of the initial seeds are selected in order to generate the offspring seeds corresponding to the new population using the crossover rate and the mutation rate. Again, the k-means algorithm and the simulated algorithm are applied on the new population of seeds to determine the distance of each new seed from the customer location in order to generate updated second solution and updated fourth solution respectively. The updating of the second solution and the fourth solution is iteratively performed based on predetermined criteria. Finally, the second solution and the fourth solution are generated based on the iteration of the genetic algorithm in accordance with the predetermined criteria. After the generation of the first solution, the second solution (most recently updated), the third solution, and the fourth solution (most recently updated), the system 102 may obtain a preliminary optimal solution using a comparing module 218 as explained below.

### Comparing Module 218

The comparing module 218, as shown in FIG. 2, may be configured to compare the distances determined in the first solution, the second solution, the third solution, and the fourth solution from the customer locations. The comparison of the distances enables in obtaining a preliminary optimal solution having a least distance from the customer locations. More specifically, the preliminary optimal solution is one of the first solution, the second solution, the third solution, and the fourth solution having least distance from the customer locations. The preliminary optimal solution is indicative of a preliminary facility location to be set up in the region serving to the customer locations. Specifically, each customer location is allocated to the preliminary facility location corresponding to the preliminary optimal solution. More particularly, the preliminary solution is a seed (one of the initial seeds or the offspring seeds) comprising preliminary solutions (one or more customer locations identified from the master data set or generated randomly, as the case may be) equivalent to the number of facility locations to be set up in the region. The preliminary optimal solution is further optimized using an optimal solution generation module 220 by applying Mixed-integer linear programming (MILP) on the preliminary optimal solution.

### Optimal Solution Generation Module 220

The optimal solution generation module 220 receives the preliminary optimal solution. The optimal solution generation module 220 then applies the Mixed-integer linear programming (MILP) based mathematical model on the preliminary optimal solution using a cost constraint, a time constraint, and a service constraint in order to obtain the final optimal solution which indicates the facility location to be set up in the region. More particularly, each customer location is allocated to a final facility location corresponding to the final optimal solution. The final optimal solution indicates a seed comprising one or more facility locations capable of serving the allocated customer locations. The generation of the final optimal solution is described in detail hereinafter.

In one implementation, the optimal solution generation module 220 may be configured to receive the cost constraint, the time constraint, and the service constraint from one or more customers associated to the customer locations. In one example, the cost constraint comprises facility location fixed cost, salvage cost, variable cost, and transportation cost. Further, the time constraint comprises road constraint, service level distance constraint, customer allocation constraint, and demand allocation constraint. Furthermore, the service constraint comprises capacity of the facility location, number of the facility locations to be setup, penalty for unsatisfied demand, priority facility location, and safety stock constraint. The optimal solution generation module 218 applies the MILP based mathematical model using the cost constraint, the time constraint, and the service constraint. The MILP based mathematical model may be represented as an Objective Function shown below:

$$Z = {\sum }_{j = 1}^{w} {F}_{j} □ {O}_{j} + {\sum }_{i = 1}^{I} {\sum }_{j = 1}^{W} {H}_{j} □ {L}_{i} □ {AC}_{ij} + {\sum }_{j = 1}^{W} {SS}_{j} □ {H}_{j} □ {O}_{j} + {\sum }_{i = 1}^{I} {\sum }_{j = 1}^{W} {TC}_{ij} □ {L}_{i} □ {D}_{ij} □ {AC}_{ij}$$

$$Subject to , \\ {\sum }_{j = 1}^{W} {AC}_{ij} = 1 ∀ i$$

$${\sum }_{i = 1}^{I} {AC}_{ij} \leq 10000 □ {O}_{j} ∀ j$$

$${\sum }_{i = 1}^{I} {AC}_{ij} \geq {O}_{j} ∀ j$$

$${L}_{i} □ {\sum }_{j = 1}^{W} □ {AC}_{ij} = 1 ∀ i$$

$${\sum }_{j = 1}^{W} {O}_{j} = N$$

$${\sum }_{i = 1}^{I} {iD}_{ij} □ {AC}_{ij} \geq ( {\sum }_{i = 1}^{I} {AC}_{ij} □ {PC}_{j} ) / 100 ∀ i$$

$${\sum }_{i = 1}^{I} {iD}_{ij} □ {L}_{i} □ {AC}_{ij} \geq ( {\sum }_{i = 1}^{I} {AC}_{ij} □ {L}_{i} □ {PD}_{j} ) / 100$$

$${O}_{k} = {WF}_{k} ∀ k$$

### Where,

j=1, . . . , W Warehouses
i=1, . . . , I Customers
k=1, . . . , Wl Number of warehouses fixed
N Upper bound on number of warehouses

### Lᵢ Demand Qty of Customer i

Dᵢⱼ Distance b/w the Customer i and warehouse j

### Fⱼ Fixed Cost of Warehouse j

### Hⱼ Handling Cost of Warehouse j

Oⱼ assume value 1 if the Warehouse is open; 0 otherwise
ACᵢⱼ assume value 1 if the customer i is assigned to warehouse j; 0 otherwise
TCᵢⱼ Transportation cost b/w the customer i and warehouse j
PCⱼ Min Percentage of Customers to be served by Warehouse j
PDⱼ Min Percentage of Demand to be satisfied by Warehouse j
WFₖ assume value 1 for fixed warehouse; 0 otherwise
Safety stock SS=(Z_{Score}□√ (̅L̅T̅)̅□σ_{d})
The distance of each warehouse from the customer locations may be calculated using following formulation:

Numerator=(Cos(Laᵢ/radConvFactor)*Sin(Abs(Loⱼ/radConvFactor−Loᵢ/radConvFactor)))**2+(Cos(Laᵢ/radConvFactor)*Sin(Laᵢ/radConvFactor)−(Sin(Laᵢ/radConvFactor)*Cos(Laᵢ/radConvFactor)*Cos(Abs(Loᵢ/radConvFactor Loᵢ/radConvFactor))))**2;

Numerator=numerator**(½);

Denominator=Sin(LairadConvFactor)*Sin(Laᵢ/radConvFactor)+(Cos (Laⱼ/radConvFactor)*Cos(Laᵢ/radConvFactor)*Cos(Abs(Loᵢ/radConvFactor−Loᵢ/radConvFactor)));

x=Tan inverse(numerator/denominator);

Distance(i,j)=x*greatCircleRadius;

RadConvFactor=57.29583;

GreatCircleRadius=3960.717837 miles;

### Where,

### Z_{Score} Safety Factor

### LT Lead Time

σ_{d} Demand Std. Deviation
Laᵢ, Loᵢ are Latitude and longitude Positions of location i

Thus, the above objective function enables the optimal solution generation module 220 to generate the final optimal solution indicating the facility location to be set up in the region. In one implementation, mathematical solvers may be utilized to compute solutions to problems derived from the aforesaid objective function. The mathematical solvers are software packages capable of solving Linear Programming (LP), Mixed Integer Programming (MIP), Mixed Integer Programming (MILP) Programming related problems. In one example, the present disclosure facilitates utilizing GNU Linear Programming Kit (GLPK) solver for solving the MILP problems in order to obtain the final optimal solution. The determination of the facility location to be set up in the region is further explained with an example, as described below.

In one exemplary embodiment, let us consider number of facility locations to be set up is 7, the population size is 10, the crossover rate is 0.9, and the mutation rate is 0.17. Further, consider the number of customer locations is 143. Further, consider that the master data set comprises exact locations of the 143 customer locations, and the latitude-longitude information (geo-spatial co-ordinates) associated to each customer location. Furthermore, let us consider maximum tolerance (predefined range) for total distance to be travelled for each customer location from the facility locations is 154445. The first step for determining the facility locations is to generate initial seeds based on the population size. Since, the population size=10, the initial seeds generated will also be 10. Let us consider, following 10 seeds are generated as initial seeds.

[1 2 3 4 5 6 7],
[200 3 6 7 8 100 50],
[50 100 150 200 25 75 30],
[20 40 60 80 100 120 140],
[15 30 45 60 75 90 105],
[10 20 30 40 50 60 70],
[5 10 15 20 25 30 35],
[4 8 12 16 20 24 28],
[3 6 9 12 15 18 21], and
[2 4 6 8 10 12 14]

It is to be understood that the each initial seed above comprises 7 potential facility locations (selected randomly from the 143 customer locations). After the generation of the initial seeds, the k-means algorithm is applied on each initial seed to calculate distance of each of the 143 customer locations from the potential facility locations comprised in each initial seed. Let is consider the k-means algorithm is implemented on the first initial seed [1 2 3 4 5 6 7] using following mathematical formula:

Numerator=(Cos(Latitude1/radConvFactor)*Sin(Abs(Longitude/radConvFactor−Longitude1/radConvFactor)))**2+(Cos(Latitude/radConvFactor)*Sin(Latitude1/radConvFactor)−(Sin(Latitude/radConvFactor)*Cos(latitude1/radConvFactor)*Cos(Abs(Longitude/radConvFactor−Longitude1/radConvFactor))))**2;

Numerator=numerator**(½);

Denominator=Sin(Latitude/radConvFactor)*Sin(Latitude1/radConvFactor)+(Cos (Latitude/radConvFactor)*Cos(Latitude1/radConvFactor)*Cos(Abs (Longitude/radConvFactor−Longitude1/radConvFactor)));

x=Tan inverse(numerator/denominator);

Distance=x*greatCircleRadius;

RadConvFactor=57.29583;

GreatCircleRadius=3960.717837 miles;

Assume the initial seed comprising the customer locations 1, 2, 3, 4, 5, 6, and 7 is identified as an initial potential facility location. Now, the distance of customer locations from the facility locations is to be calculated which is done as follows.

Locations (latitude, longitude) of the facilities belonging to the initial seed are as follows:

| Latitude | Longitude |
|---|---|
| 61.2180556 | −149.9002778 |
| 64.8377778 | −147.7163889 |
| 58.3019444 | −134.4197222 |
| 33.5206608 | −86.80249 |
| 31.2232313 | −85.3904888 |
| 34.6059253 | −86.9833417 |

Further, distance from all facilities to all customer locations is calculated by substituting values in the above mathematical formula. After the calculation, the customer locations are allocated to nearest facility having minimum distance. Then a centroid is determined for customer locations assigned to each facility. After the determination of the centroid, the locations (latitude, longitude) of the facility is:

| Latitude | Longitude |
|---|---|
| 41.2625 | −153.8793056 |
| 64.8377778 | −147.7163889 |
| 42.78832263 | −119.3204375 |
| 30.81692218 | −91.45753296 |
| 30.71846808 | −83.22928497 |
| 40.06579933 | −78.28952317 |

Again the distance of each facility from all customer locations is calculated and each customer location is assigned to a facility based on minimum distance. Then a centroid for all customers assigned to facility. The process is iteratively performed until a stabilized facility location is obtained. Further, the facility locations so obtained is compared with the master data set. If the facility locations are not present in the master data set, distance from all possible locations to the facility locations is computed. The locations from the facility locations nearest to the master data set are selected. The total distance to be travelled from the selected location to the customer locations is 158446.2947 miles. The above methodology is performed for all initial seeds. Finally, a seed, a distance, and a cluster are considered as a best seed, a best distance, and best cluster having lowest total distance to be travelled. These seeds are referred to as the first solution.

After the generation of the first solution, the simulated annealing algorithm is applied on each seed of the initial seeds. Let us consider, Initial temperature=2500, Final temperature=1800, and Temperature reduction factor=0.9. Assume, Temp=initial temperature. If (temp>=final temperature), Take initial seed=[1 2 3 4 5 6 7]. Current initial seed=[1 2 3 4 5 6 7] and the distance of the current initial seed is current distance=158446.2947. Now, generate a random number (excluding 1, 2, 3, 4, 5, 6, 7) from 1 to 243. Assume the number is 100. Therefore, the working initial seed is [100 2 3 4 5 6 7]. Apply k-means to the working initial seed. Based on the k-means algorithm, assume the total distance to be travelled for the working initial seed is 158999 miles (also referred to as a working distance). Now, since the working distance>the current distance, calculate P=exp (−(current distance−working distance)/temp)=exp (−(158446−158999)/2500)=0 0.81. Then again generate random number (between 0-1). In one example, consider the random number generated is 0.7. Since the value of P>0.7, therefore the current initial seed=[100 2 3 4 5 6 7]. In another example, consider the random number generated is 0.9. Since in this example, P<0.9 therefore the current initial seed=[1 2 3 4 5 6 7]. The total distance to be travelled for the working initial seed 154000 (working distance). So working distance<current distance, therefore the current initial seed=[100 2 3 4 5 6 7]. The above steps are performed iteratively in order to identify one or more seeds referred to as the third solution.

Further, chromosomes may be selected for applying crossover using the genetic algorithm. Initially one initial seed is randomly selected and a random number is generated for the initial seed selected. In one example, assume the random number generated for the initial seed is 0.8. Since, the crossover rate is 0.9>0.8, therefore the initial seed is selected. Further, another initial seed is selected and assigned a random number 0.859. Again since the crossover rate is 0.9>0, therefore another initial seed is also selected. Now one of the two initial seeds is selected based on minimum total distance to be travelled. In this example, assume the initial seed is [1 2 3 4 5 6 7] having the distance=158446.2947. Further, consider another initial seed is [100 2 3 4 5 6 7] having the distance=158222. Therefore, based on the minimum distance, another initial seed is selected as a chromosome for applying the cross over. The aforementioned steps are iteratively performed until the selected number of chromosomes is equal to the population size. Therefore, we now have the chromosomes to apply the cross over operator. In one example, consider the following initial seeds are selected for applying the crossover operator.

[1 2 3 4 5 6 7],
[1002 3 4 5 6 7],
[50 100 150 200 25 75 30],
[20 40 60 80 100 120 140],
[15 30 45 60 75 90 105],
[10 20 30 40 50 60 70],
[3 6 9 12 15 18 21],
[1002 3 4 5 6 7],
[10 20 30 40 50 60 70], and
[50 100 150 200 25 75 30]

The applying of the Crossover operator on the above initial seeds generates new initial seeds (also referred to as offspring seeds offspring seeds). For example, consider the two seeds [100 2 3 4 5 6 7] and [50 100 150 200 25 75 30]. Randomly select two positions between 2 and 6. Assume the positions are 3 and 5. Then, the two seeds may be represented as [100 2 31 4 5 16 7] and [50 100 150 1200 251 75 30]. Therefore, the new initial seeds (offspring seeds) are [100 2 3 200 25 6 7] and [50 100 150 4 5 75 30]. Similarly the crossover operator is applied for all pairs of initial seeds. Then, the k-means algorithm is applied on all the new initial seeds (offspring seeds) generated thereby updating the best seed, the best distance, and the best cluster. The offspring seeds are also generated using the mutation rate explained further with an example.

Let us assume, for each initial seed, a random number (between 0 and 1) is generated. When the random number is less than the mutation rate, a new initial seed (offspring seed) is generated. In one example, assume the initial seed is [100 2 3 200 25 6 7] and the random number generate is 0.05. Since the random number<0.17, generate a number randomly from 1 to 243 and excluding 100, 2, 3, 200, 25, 6, 7. Let us assume that the number generated randomly is 250, therefore the new initial seed (offspring seed) is [250 2 3 200 25 6 7]. Then, the k-means algorithm is applied on all the new initial seeds (offspring seeds) generated thereby updating the best seed, the best distance, and the best cluster. The Initial seeds (offspring seeds) generated by using the cross over and mutation operators are considered to be the second solution. Further, the simulated annealing algorithm is applied on each offspring seeds thereby updating the best seed, the best distance, and the best cluster. These seeds are referred to as the fourth solution.

The second solution and the fourth solution may be iteratively updated using a Replacement strategy. The Replacement strategy is used for selection of initial seeds for generating next generation of population. In the Replacement strategy, at each iteration, initial seeds having total distance to be travelled more than the maximum tolerance are excluded. All the potential locations are merged and sorted based on distance travelled. In one implementation the top initial seeds (25% of the population size) are retained while the remaining initial seeds (75% of the population) are selected randomly for the next generation of solutions.

Finally, the distances determined for the first set of solutions, the second set of solutions, the third set of solutions, and the fourth set of solutions are compared in order to obtain a preliminary optimal solution (indicative facility locations) having the least distance from all the customer locations (1-243). Further, based upon the cost constraint, the time constraint, and the service constraint, the preliminary optimal solution is optimized in order to determine the final optimal solution (indicative final facilities to be set up) using the MILP based mathematical model as described above.

Exemplary embodiments discussed above may provide certain advantages. Though not required to practice aspects of the disclosure, these advantages may include those provided by the following features.

Some embodiments of the present disclosure enable the genetic algorithm (GA) capable of exploring a search space by generating initial seeds for clustering.

Some embodiments of the present disclosure enable the simulated annealing (SA) algorithm capable of exploring the search space to obtain a local optimal solution.

Some embodiments of the present disclosure enable a mathematical model for considering various constraints and hence not limiting to distance optimization.

Some embodiments of the present disclosure enable combining simulated annealing (SA) algorithm and the MILP based mathematical model with the clustering in order to improve probability to obtain a global optimal solution.

Referring now to FIG. 3, a method 300 for determining a facility location to be setup in a region for catering customer locations present in the region is shown, in accordance with an embodiment of the present disclosure. The method 300 may be described in the general context of computer executable instructions. Generally, computer executable instructions can include routines, programs, objects, components, data structures, procedures, modules, functions, etc., that perform particular functions or implement particular abstract data types. The method 300 may also be practiced in a distributed computing environment where functions are performed by remote processing devices that are linked through a communications network. In a distributed computing environment, computer executable instructions may be located in both local and remote computer storage media, including memory storage devices

The order in which the method 300 is described is not intended to be construed as a limitation, and any number of the described method blocks can be combined in any order to implement the method 300 or alternate methods. Additionally, individual blocks may be deleted from the method 300 without departing from the spirit and scope of the disclosure described herein. Furthermore, the method can be implemented in any suitable hardware, software, firmware, or combination thereof. However, for ease of explanation, in the embodiments described below, the method 300 may be considered to be implemented in the above described system 102.

At block 302, a plurality of variables along with geo-spatial co-ordinates of the customer locations may be received. In one implementation, the plurality of variables and the geo-spatial co-ordinates may be received by the receiving module 212. In one implementation, the plurality of variables and the geo-spatial co-ordinates may be stored in the database 224. The plurality of variables comprises a population size, a cross over rate, and mutation rate for the region.

At block 304, initial seeds may be generated in the region based upon the population size. The initial seeds may indicate a first set of potential facility locations. In one implementation, the initial seeds may be generated by the seed generation module 214. In one embodiment, the initial seeds generated may be stored in the database 224.

At block 306, offspring seeds may be generated in the region by applying genetic algorithm on a sub-set of the initial seeds using the crossover rate and the mutation rate. The offspring seeds may indicate a second set of potential facility locations. In one implementation, the offspring seeds may be generated by the seed generation module 214. In one embodiment, the offspring seeds generated may be stored in the database 224.

At block 308, a first solution and a second solution may be generated by applying a k-means algorithm on the initial seeds and the offspring seeds respectively. The first solution may indicate a first set of the initial seeds having a distance within a predefined range from the customer locations. Further, the second solution may indicate a first set of offspring seeds having a distance within a predefined range from the customer locations. In one implementation, the first solution and the second solution may be generated by the solution generation module 216.

At block 310, a third solution and a fourth solution may be generated by applying a simulated annealing algorithm on the initial seeds and the offspring seeds respectively. The third solution may indicate a second set of the initial seeds having a distance within a predefined range from the customer locations. Further, the fourth solution may indicate a second set of offspring seeds having a distance within a predefined range from the customer locations. In one implementation, the third solution and the fourth solution may be generated by the solution generation module 216.

At block 312, distances determined in the first solution, the second solution, the third solution, and the fourth solution from the customer locations may be compared in order to obtain preliminary optimal solution having a least distance from the customer locations. In one implementation, the distances may compared by the comparing module 218.

At block 314, a final optimal solution may be determined by applying mixed-integer linear programming (MILP) on the preliminary optimal solution using a cost constraint, a time constraint, and a service constraint. The final optimal solution indicates the facility location to be set up in the region. In one implementation, the final optimal solution may be determined by the optimal solution generation module 220.

Although implementations for methods and systems for determining a facility location to be setup in a region for catering customer locations present in the region have been described in language specific to structural features and/or methods, it is to be understood that the appended claims are not necessarily limited to the specific features or methods described. Rather, the specific features and methods are disclosed as examples of implementations for determining a facility location to be setup in a region for catering customer locations present in the region.

What is claimed is:

1. A computer implemented method for determining a location of a facility, the method comprising:
receiving, by one or more processors,
a plurality of variables, including a population size, a crossover rate, and a mutation rate associated with a region, and
geo-spatial coordinates associated with customer locations located in the region;
generating, by the one or more processors, initial seeds for the region based on the population size, the initial seeds reflecting a first set of potential facility locations;
generating, by the one or more processors, offspring seeds by applying a genetic algorithm on a sub-set of the initial seeds using the crossover rate and the mutation rate, the offspring seeds reflecting a second set of potential facility locations;
generating, by the one or more processors, a first solution and a second solution associated with the region by applying a k-means algorithm on the initial seeds and on the offspring seeds, the first solution including a first portion of the initial seeds having a distance from the customer locations within a predefined range, and the second solution including a first portion of the offspring seeds having a distance from the customer locations within a predefined range;
generating, by the one or more processors, a third solution and a fourth solution associated with the region by applying a simulated annealing algorithm and the k-means algorithm on the initial seeds and the offspring seeds, the third solution including a second portion of the initial seeds having a distance from the customer locations within the predefined range, and the fourth solution including a second set of offspring seeds having a distance from the customer locations within the predefined range;
comparing the distances of the first solution, the second solution, the third solution, and the fourth solution in order to obtain a preliminary optimal solution having a shortest distance from the customers locations; and
determining, by the one or more processors, a final optimal solution by applying Mixed-integer linear programming (MILP) on the preliminary optimal solution using a cost constraint, a time constraint, and a service constraint, the final optimal solution reflecting a location in the region for placement of the facility.

2. The method of claim 1, wherein the location for placement of the facility comprises one of a warehouse location, a retailer location, a manufacturer location, a store location, and a service provider location.

3. The method of claim 1, wherein the cost constraint comprises one of a facility location fixed cost, a salvage cost, a variable cost, and a transportation cost.

4. The method of claim 1, wherein the time constraint comprises one of a road constraint, a service level distance constraint, a customer allocation constraint, and a demand allocation constraint.

5. The method of claim 1, wherein the service constraint comprises one of a capacity of the facility location, a number of the facility locations to be setup, a penalty for unsatisfied demand, a priority facility location, and a safety stock constraint.

6. The method of claim 1, wherein the geo-spatial coordinates comprise information pertaining to a latitude and a longitude of the customer locations.

7. The method of claim 1, wherein:
the first solution and the third solution are generated based on a distance from the customer locations of each seed of the initial seeds, the distance of each seed of the initial seed being obtained based on the geo-spatial coordinates, and
the second solution and the fourth solution are generated based on a distance from the customer locations of each seed of the offspring seed, the distance of each seed of the offspring seeds being obtained based on the geo-spatial coordinates.

8. The method of claim 1, wherein the distances of the first portion of the initial seeds, the second portion of the initial seeds, the first portion of the offspring seeds, and the second portion of the offspring seeds are curve-linear distances.

9. A system for determining a location of a facility, the system comprising:
one or more hardware processors; and
one or more memory units storing machine readable instructions executable by the one or more processors for:
receiving:
a plurality of variables, including a population size, a crossover rate, and a mutation rate associated with a region, and
geo-spatial coordinates associated with customer locations located in the region;
generating initial seeds for the region based on the population size, the initial seeds reflecting a first set of potential facility locations;
generating offspring seeds by applying a genetic algorithm on a sub-set of the initial seeds using the crossover rate and the mutation rate, the offspring seeds reflecting a second set of potential facility locations;
generating a first solution and a second solution associated with the region by applying a k-means algorithm on the initial seeds and on the offspring seeds, the first solution including a first portion of the initial seeds having a distance from the customer locations within a predefined range, and the second solution including a first portion of the offspring seeds having a distance from the customer locations within a predefined range;
generating a third solution and a fourth solution associated with the region by applying a simulated annealing algorithm and the k-means algorithm on the initial seeds and the offspring seeds, the third solution including a second portion of the initial seeds having a distance from the customer locations within the predefined range, and the fourth solution including a second set of offspring seeds having a distance from the customer locations within the predefined range;
comparing the distances of the first solution, the second solution, the third solution, and the fourth solution in order to obtain a preliminary optimal solution having a shortest distance from the customers locations; and
determining a final optimal solution by applying Mixed-integer linear programming (MILP) on the preliminary optimal solution using a cost constraint, a time constraint, and a service constraint, the final optimal solution reflecting a location in the region for placement of the facility.

10. The system of claim 9, wherein the location for placement of the facility comprises one of a warehouse location, a retailer location, a manufacturer location, a store location, and a service provider location.

11. The system of claim 9, wherein the cost constraint comprises one of a facility location fixed cost, a salvage cost, a variable cost, and a transportation cost.

12. The system of claim 9, wherein the time constraint comprises one of a road constraint, a service level distance constraint, a customer allocation constraint, and a demand allocation constraint.

13. The system of claim 9, wherein the service constraint comprises one of a capacity of the facility location, a number of the facility locations to be setup, a penalty for unsatisfied demand, a priority facility location, and a safety stock constraint.

14. The system of claim 9, wherein the geo-spatial coordinates comprise information pertaining to a latitude and a longitude of the customer locations.

15. The system of claim 9, wherein:
the first solution and the third solution are generated based on a distance from the customer locations of each seed of the initial seeds, the distance of each seed of the initial seed being obtained based on the geo-spatial coordinates, and
the second solution and the fourth solution are generated based on a distance from the customer locations of each seed of the offspring seed, the distance of each seed of the offspring seeds being obtained based on the geo-spatial coordinates.

16. The system of claim 9, wherein the distances of the first portion of the initial seeds, the second portion of the initial seeds, the first portion of the offspring seeds, and the second portion of the offspring seeds are curve-linear distances.

17. A non-transitory computer readable medium storing machine readable instructions executable by one or more processors for:
receiving:
a plurality of variables, including a population size, a crossover rate, and a mutation rate associated with a region, and
geo-spatial coordinates associated with customer locations located in the region;
generating initial seeds for the region based on the population size, the initial seeds reflecting a first set of potential facility locations;
generating offspring seeds by applying a genetic algorithm on a sub-set of the initial seeds using the crossover rate and the mutation rate, the offspring seeds reflecting a second set of potential facility locations;
generating a first solution and a second solution associated with the region by applying a k-means algorithm on the initial seeds and on the offspring seeds, the first solution including a first portion of the initial seeds having a distance from the customer locations within a predefined range, and the second solution including a first portion of the offspring seeds having a distance from the customer locations within a predefined range;
generating a third solution and a fourth solution associated with the region by applying a simulated annealing algorithm and the k-means algorithm on the initial seeds and the offspring seeds, the third solution including a second portion of the initial seeds having a distance from the customer locations within the predefined range, and the fourth solution including a second set of offspring seeds having a distance from the customer locations within the predefined range;
comparing the distances of the first solution, the second solution, the third solution, and the fourth solution in order to obtain a preliminary optimal solution having a shortest distance from the customers locations; and
determining a final optimal solution by applying Mixed-integer linear programming (MILP) on the preliminary optimal solution using a cost constraint, a time constraint, and a service constraint, the final optimal solution reflecting a location in the region for placement of the facility.

18. The medium of claim 17, wherein:
the first solution and the third solution are generated based on a distance from the customer locations of each seed of the initial seeds, the distance of each seed of the initial seed being obtained based on the geo-spatial coordinates, and
the second solution and the fourth solution are generated based on a distance from the customer locations of each seed of the offspring seed, the distance of each seed of the offspring seeds being obtained based on the geo-spatial coordinates.

19. The medium of claim 17, wherein the distances of the first portion of the initial seeds, the second portion of the initial seeds, the first portion of the offspring seeds, and the second portion of the offspring seeds are curve-linear distances.

20. The medium of claim 17, wherein the location for placement of the facility comprises one of a warehouse location, a retailer location, a manufacturer location, a store location, and a service provider location.
